(19) United States
(12) Patent Application Publication
(10) Pub. No.: US 2010/0015571 A1
(43) Pub. Date: Jan. 21, 2010

(54) Flexible Abutment For Use With A Dental Implant

(75) Inventor: Wasseem Al-Attar, Lexington, MA (US)

Correspondence Address: HARNESS, DICKEY & PIERCE, P.L.C., P.O. BOX 828, BLOOMFIELD HILLS, MI, 48303, US

(73) Assignee: Global Implant Solutions, LLC, Bedford, MA (US)

(21) Appl. No.: 12/490,800

(22) Filed: Jun. 24, 2009

Related U.S. Application Data
(60) Provisional application No. 61/134,907, filed on Jul. 15, 2008.

(51) Int. Cl. A61C 8/00

(52) U.S. Cl. 433/173

(57) ABSTRACT

A flexible abutment is provided to allow a prosthetic tooth or other dental device to simulate the flexibility of a natural tooth to provide protection from accidental sudden forces affecting the implant and allows for connection between a natural tooth and the implant, such as by a bridge.

### CROSS-REFERENCE TO RELATED APPLICATIONS

This application claims the benefit of U.S. Application No. 61/134,907 filed on Jul. 15, 2008.

### FIELD

The present disclosure relates to a dental implant system and more particularly, to a flexible abutment design to simulate the flexibility of a natural tooth.

### BACKGROUND AND SUMMARY

This section provides background information related to the present disclosure which is not necessarily prior art and provides a general summary of the disclosure, and is not a comprehensive disclosure of its full scope or all of its features.

Dental implants are screwed or otherwise inserted into a prepared site in a jaw bone and serve as a fixture on which a prosthetic tooth or other dental appliance can be mounted. Dental implants have been in clinical use as a predictable treatment modality for more than 40 years and are well known in the art. Dental implants have various external shapes and generally fall into one of three categories including threaded (with different thread geometry and configurations), cylinders (with or without various features such as grooves, holes, etc.) and stepped. Additionally, dental implants can also be classified into two categories depending upon the connection at the neck into two broad categories including implants with external connections with different shapes, designs and configurations including hex, square, etc and implants with internal connections with different shapes designs and configurations including hex, octagon, tri-lobe and double helix.

Dental implants are inserted into the jaw bone via a surgical procedure where the bone is drilled and an osteotomy site is prepared to certain dimensions depending on the implant design, size, and shape. To deliver the implant into the osteotomy site, a carrier mechanism is needed to connect the implant to a ratchet, torque device, or dental handpiece. This carrier mechanism can be in the form of a driver or a surgical mount. Certain indexing features are needed to provide anti-rotational characteristics during the insertion process. For externally connected implants such as the externally hexed implants, a driver or mount with a slightly larger but matching hexed concavity is used to fit over the external hex of the implant. This driver is secured with a fastener screw sometimes to provide a secure connection and help drive the implant to the site. For internally connected implants, the driver or mount relies on internal configurations for anti-rotation to deliver the implant to the site. Drivers can rely on internal hexes, octagons, or other features to engage the implant. The drivers and mounts generally have a similar shape but slightly smaller dimension to the inside of the implant in order to fit inside the implant. For example, an implant with an internal octagon concavity can use a driver with an octagon cross-section with a slightly smaller dimension as a driver and so on. In terms of patient safety, the implant is the only implantable part of the system and should have the entire system designed to maximize its efficacy and safety. The jaw bones of patients come in different densities with the lower jaws of higher density than upper jaws. Depending on the bone density, the osteotomy preparation, and the external shape of the implant, extremely high torque values can be reached during the implant insertion process.

One potential problem with dental implants having internal connections is that the interior cavity that defines the internal connection is surrounded by a thin wall portion. It is desirable to maintain the implant with as small of a size as possible for adequately supporting a prosthetic tooth while maintaining sufficient strength to withstand the torques applied to the dental implant during insertion and to provide a strong connection between the dental implant and the prosthetic tooth.

According to one aspect of the present disclosure, a dental implant includes a threaded shank portion and a head portion extending from the shank portion and including a recessed cavity in an axial end thereof. The recessed cavity has a cone shaped region extending from the axial end of the head portion and a multi-sided region extending from the cone shaped region in a direction extending away from the axial end of the head portion. The geometry of the multi-sided region provides for improved wall strength while maintaining a small head profile.

Dental implants tend to adhere to the jaw bone through the process known as ossteointegration. Ossteointegration typically allows no mobility at the junction between the bone and the implant fixture compared to natural teeth that are anchored to the bone with a fibrous membrane that allow some resilience and some shock absorption.

According to still another aspect, a flexible abutment is provided including a first end configured for engagement with a dental implant, and a second end adapted for engagement with a dental prosthetic device. The flexible abutment includes a flex region disposed between the first and second ends. The flexible abutment provides a cushioning effect from usual occlusual forces similar to that produced by the periodontal ligament that exists around natural teeth. The flexible abutment also provides protection from accidental sudden forces affecting the implant, whether such forces are produced by foreign objects or by natural teeth through parafunctional habits such as Bruxing. The protection is three dimensional and also allows the connection between natural teeth and implants, such as by a bridge. With the natural teeth having flexibility due to the periodontal ligaments, the flexible abutment allows a bridge to be connected between the flexible abutment and a natural tooth. Previously the rigidity of standard implants and abutments prevented a bridge from being used for connection between an implant and a natural tooth.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side plan view of a dental implant according to the principles of the present disclosure;

FIG. 2 is a cross-sectional view taken longitudinally of the dental implant of FIG. 1;

FIG. 3 is a detailed enlarged view of the head portion of the dental implant shown in FIG. 1;

FIG. 4 is an enlarged detail view of a portion of the threaded shank of the dental implant shown in FIG. 1;

FIG. 5 is an end view of the head portion of the dental implant shown in FIG. 1;

FIG. 6 is an end view of the threaded shank portion of the dental implant shown in FIG. 1;

FIG. 7 is a perspective view of a digital abutment according to the principles of the present disclosure;

FIG. 8 is a cross-sectional view showing the attachment of the digital abutment to a dental implant according to the principles of the present disclosure;

FIG. 9 is a cross-sectional view of an exemplary prosthetic screw according to the principles of the present disclosure;

FIG. 10 is a perspective view of a flexible prosthetic abutment according to the principles of the present disclosure;

FIG. 11 is a cross-sectional view illustrating the connection of the flexible prosthetic abutment to a dental implant according to the principles of the present disclosure; and

FIG. 12 is a side plan view illustrating the connection of the flexible prosthetic abutment to a dental implant according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

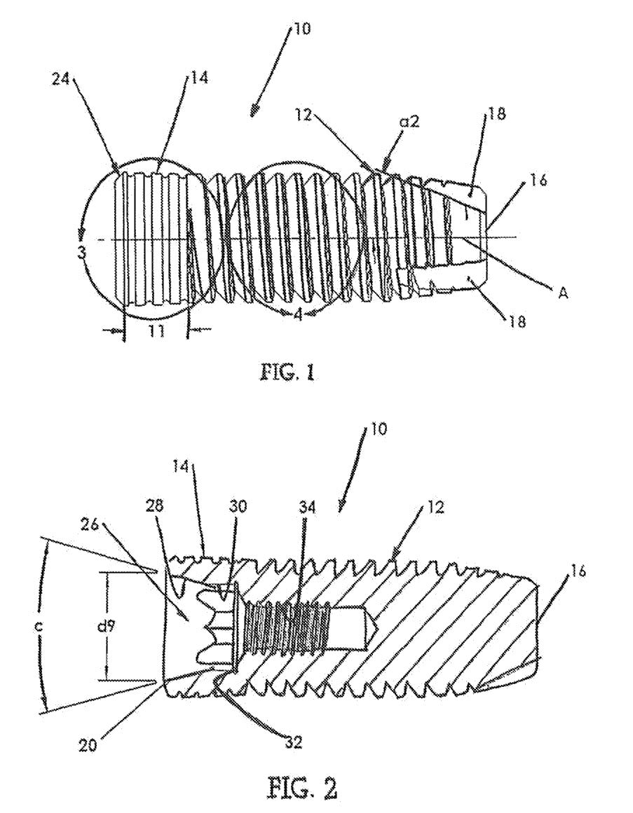

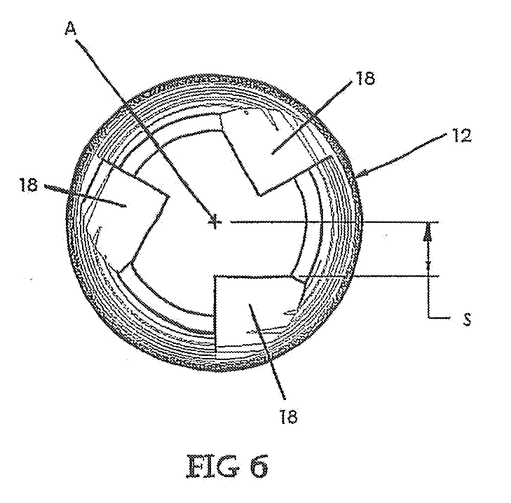

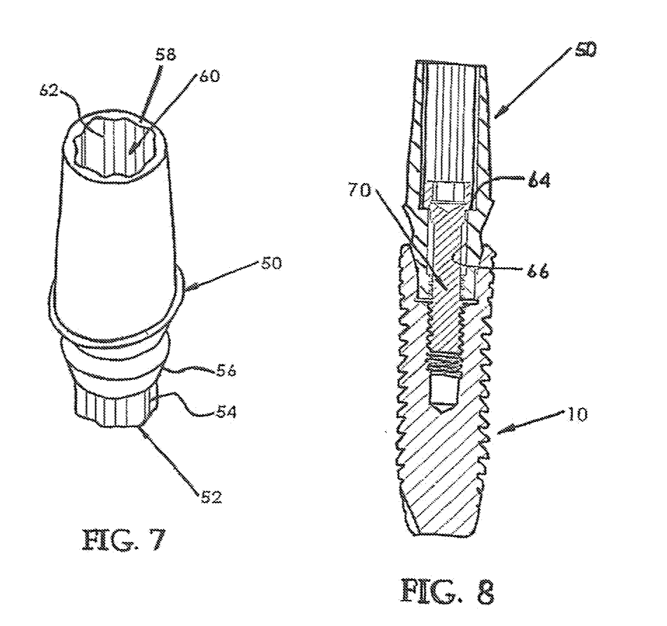

With reference to FIGS. 1-6, a dental implant 10 according to the principles of the present disclosure will now be described. The dental implant 10 includes a threaded shank portion 12 and a head portion 14 extending from the shank portion 12. The threaded shank portion 12 can include a standard cutting thread form. The threaded shank portion can have a sand blasted surface with a surface finish of bio-coat MPS 041 which is well known in the implant industry. The end portion 16 of the threaded shank portion 12 can be provided with tapping threads 18 as best illustrated in FIGS. 1 and 6. The tapping threads 18 can be spaced at predetermined intervals. In the embodiment shown, 120 degree intervals are provided between the tapping threads 18, although other intervals can be utilized.

In the embodiment shown, as illustrated in FIG. 4, the thread of the threaded shank portion 12 has a major diameter d1 of approximately 0.157 inches and a minor diameter d2 of 0.13 inches. Furthermore, the thread pitch P is approximately 0.028 inches while the thread angle “a” is approximately 70 degrees. It should be understood that the dimensions provided herein are for exemplary purposes only and other dimensions can be utilized. With reference again to FIG. 6, is it noted that the tapping threads 18 are defined by a radially inwardly extending cut region that is spaced a distance “s” of approximately 0.03 inches from the axis A of the dental implant. Furthermore, with reference to FIG. 1, the cut sections defining the teeth 18 are provided at an angle a2 of approximately 25 degrees relative to the axis A.

With reference to FIG. 3, a detailed enlarged view of the head portion 14 of the dental implant 10 is shown. The head portion 14 tapers slightly inward from the end 20 toward the shank portion 12. By way of example, the maximum diameter dmax of the head portion 14 can be approximately 0.1636 inches toward the end 20 while the minimum diameter dmin of the head portion can be 0.158 inches at the end proximal to the shank portion 12. The implant 10 can have multiple sizes with the maximum diameter dmax varying for each implant size, while the size and shape of the recessed cavity 26 remain the same for each size implant. The head portion 14 can be provided with a series of recessed grooves 22 in which bone growth can penetrate for securing the implant in the patient's jaw. The recessed grooves 22 can be defined by a radiused groove having a radius of approximately 0.005 inches. According to one aspect of the present disclosure, the first groove 22 closest to the end 20 of the head portion 14 can be spaced a distance D3 of approximately 0.022 inches from the end 20; the second groove 22 can be spaced a distance D4 of approximately 0.045 inches from the end 20; the third groove 22 can be spaced a distance D5 of approximately 0.069 inches from the end face 20; and the fourth groove 22 can be spaced a distance D6 of approximately 0.092 inches from the end face 20.

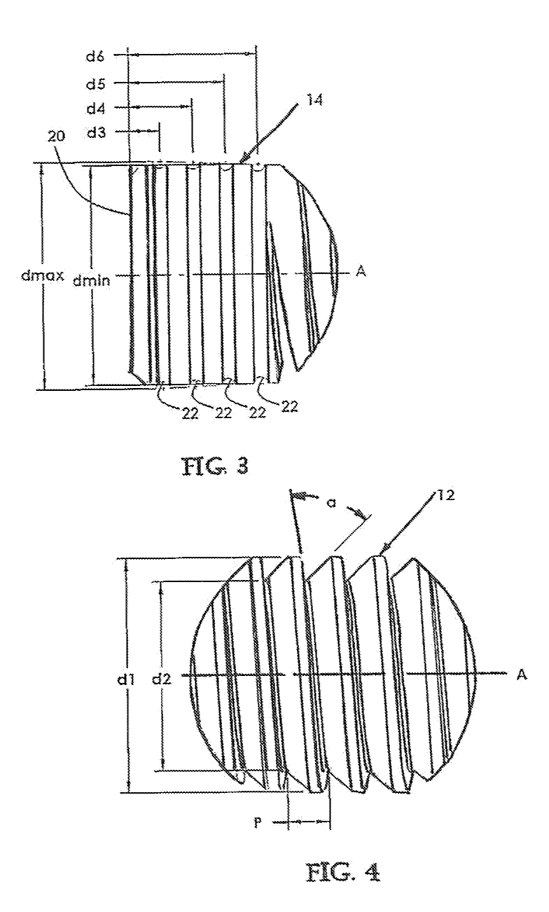

With reference to FIG. 2, the head portion 14 can have a length L1 of approximately 0.109 inches while the total length of the implant can be approximately 0.512 inches. The head portion 14 can have a chamfered surface 24 adjacent to the end face 20 that can have an electropolished finish. With reference to FIG. 2, the dental implant 10 includes a recessed cavity 26 extending axially from the end face 20. The recessed cavity includes a cone-shaped region 28 extending from said axial end 20 of the head portion 14 and a multi-sided region 30 extending from the cone-shaped region 28 in a direction extending away from the axial end 20 of the head portion 14. A shoulder 32 is provided at the end of the multi-sided region 30 and an internally threaded bore 34 extends from the shoulder 32.

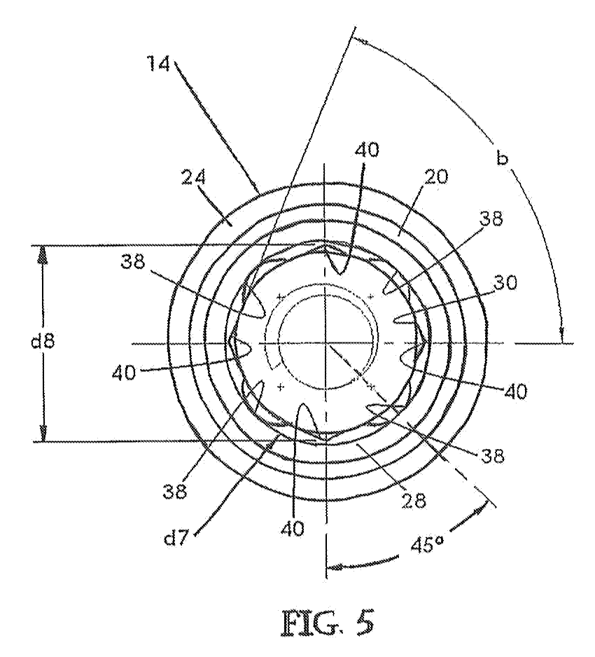

With reference to FIG. 5, the multi-sided region can include a plurality of concave curved portions 38 separated by intermediate corner portions 40 wherein the concave curved portions 38 define the largest diameter portions of the multi-sided region. In the embodiment shown, four concave curved portions 38 are provided with four corner portions 40 disposed therebetween. The multi-sided region 30, as described herein, can include other forms including square, triangle, hex, octagon, pentagon, and other shapes, however, it has been found that the arrangement as shown in FIG. 5 having four indices instead of six, is easier for purposes of allowing the prosthetic device to be designed based upon the orientation of the indices of the present design as opposed to a six-sided hex or other forms with larger numbers of indices. Furthermore, with the curved concave portions 38, defining the outermost diameter of the multi-sided region, the design of the present disclosure avoids sharp edges at the outermost portion that would otherwise define stress concentrations at the locations of the smallest wall thickness. With the curved concave portions 38, the stress concentrations can be avoided at these locations in order to strengthen the wall of the recessed cavity 30 and to allow for a minimized size of the head portion 14 of the implant 10. In the embodiment shown, the concave curved portions 38 are spaced at 90 degrees from one another and spaced at 45 degrees from the corner portions 40. The modified octagonal shape provides for distinct indexing positions for accurate transfer and repeated placement of abutments. The modified octagonal shape (four protrusions) provides for four distinct indexing positions as opposed to eight thus simplifying the procedure. By way of example only, the diameter D7 between the concave curved portions 38 can be 0.1058 inches while the diameter D8 between the corner portion can be 0.1014 inches. Furthermore, the angle of the corner portions 40 relative to a line passing through the apex of the corner portions 40 and through the center axis can be an angle b of 67.5 degrees. It should be understood that all of the dimensions provided herein are exemplary dimensions and that larger and smaller dimensions could be utilized for a desired application.

With reference to FIG. 2, it is noted that the cone-shaped region 28 of the recessed cavity 26 has an outer diameter D9 that can be 0.126 inches while the cone angle C can have an angle of between 14 and 40 degrees and more particularly 26 degrees such that the wall of the cone-shaped region 28 is angled relative to a central axis by between 7 and 20 degrees and more particular 10 and 16 degrees and more particularly 13 degrees.

The dental implant 10 cuts threads into a pre-drilled hole in a patient's jaw bone. A driver having a multi-sided end that corresponds to the multi-sided region of the recessed cavity is inserted into the recess cavity 26 and drives the implant into the bone. The material for the dental implant 10 can be Ti₆Al₄V. The inside surface of the recessed cavity 26 can have an electropolished finish.

With reference to FIGS. 7 and 8, a digital abutment 50 is shown including a first end 52 having a multi-sided region 54 and a cone-shaped region 56 for receipt in the recessed cavity 26 of a corresponding dental implant 10. The digital abutment 50 includes a second end 58 having a recessed cavity 60 therein. The recessed cavity 60 includes a multi-sided region 62 that is identical to the multi-sided region of the implant 10. The configuration of the multi-sided region 62 allows for a digital three-dimensional impression to be taken of the digital abutment 50 within a user's mouth with the orientation and alignment of the multi-sided region 30 of the recessed cavity 26 in the dental implant being duplicated at the top of the digital abutment 50. A prosthetic tooth can then be designed, machined, and placed on a prosthetic abutment without the need for an open or closed tray impression procedure based upon the scanned digital image of the digital abutment within the user's mouth.

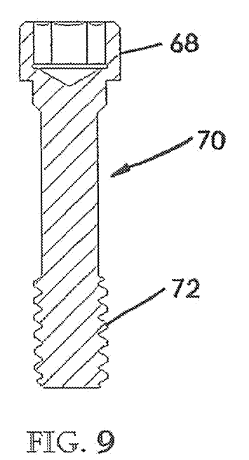

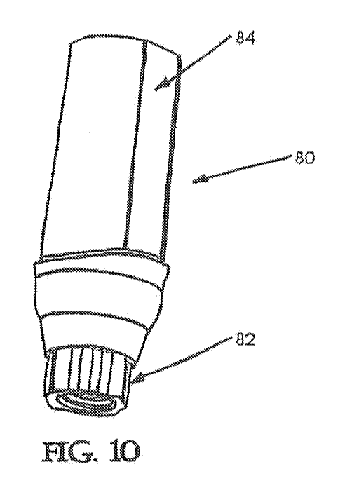

The digital abutment 50 includes a shoulder portion 64 disposed at a bottom of the recessed cavity 60 and an aperture 66 extending from the shoulder to the first end 52 of the digital abutment. The shoulder 64 provides a surface against which a head portion 68 of a prosthetic screw 70 (see FIG. 9) can seat against. The prosthetic screw 70 includes a threaded portion 72 which is threadedly engaged with the threaded bore 34 in the dental implant 10 for securing the digital abutment 50 to the dental implant 10. With prior designs, the orientation of the multi-sided region of the recessed cavity in the dental implant 10 was unknown while the abutment was in place, whereas with the digital abutment of the present disclosure, the multi-sided region of the recessed cavity of the dental implant 10 is now reproduced at the end of the digital abutment 50 for use in designing and manufacturing a prosthetic abutment and prosthetic tooth.

It should be noted that the multi-sided region 54 of the digital abutment can be designed to engage other shapes of multi-sided recesses such as triangular, square, rectangle, hex, octagon, and other shapes. However, it has been found to be particularly advantageous to utilize the specific orientation as described with reference to FIG. 5 above. The concept of the digital abutment 50 does not depend upon the specific geometry of the recessed cavity 26 of the implant and the recessed cavity 60 of the digital abutment, other than the fact that the recessed cavity 60 in the digital abutment needs to replicate the orientation and geometry of the multi-sided region 30 of the recessed cavity 26 in the dental implant 10. The digital abutment 50 can receive a temporary crown so that the digital abutment can remain in place for preserving the gingival architecture while waiting for the final crown and the final abutment.

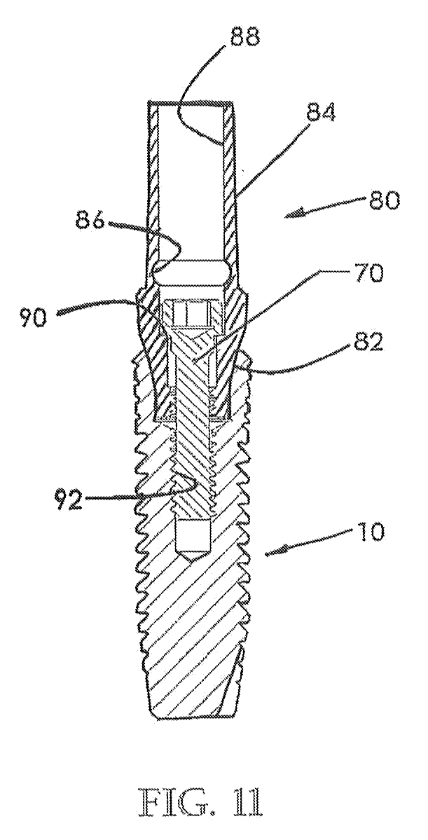

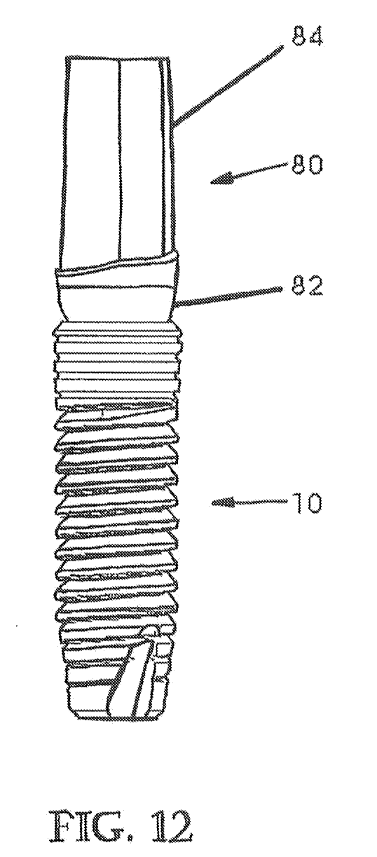

With reference to FIGS. 10-12, a flexible abutment 80 will now be described. The flexible abutment 80 is designed to be secured to a dental implant 10 utilizing a prosthetic fastener 70, as illustrated in FIG. 11. The flexible abutment 80 can include a first end having a mating portion 82 for non-rotatable engagement relative to the dental implant 10. For purposes of the flexible abutment 80, the geometry of the mating portion 82 can have the same configuration as the multi-sided region 30 of the recessed cavity 26 of the dental implant 10. The geometry of the multi-sided region 30 can be varied for providing numerous alternative geometries. In addition, the flexible abutment 80 can include either an external or internal attachment portion 82 for engaging with a corresponding internal or external attachment portion of a dental implant 10.

The flexible abutment 80 includes a second end 84 on which a prosthetic tooth or other dental prosthetic device can be attached. The flexible abutment 80 includes a flex region 86 disposed between the first and second ends 82, 84. The flex region 86 can include a reduced thickness region defined by a recesses groove on the interior or exterior of the flexible abutment 80. In the embodiment shown in FIGS. 10-12, the recessed groove is on the interior wall, while in the embodiment shown in FIG. 13, the recessed groove is on the exterior wall of the flexible abutment. The flex region 86 can include a reduced thickness region that allows for flex of the second end 84 relative to the first end 82. The flexible abutment 80 can be made of a nickel titanium alloy or other superelastic material such that the abutment 80 provides flexing similar to a natural tooth. With reference to FIG. 11, the flexible abutment 80 includes a recessed cavity 88 therein extending from a second end 84 and beyond the flex region 86. The recessed cavity 88 defines a shoulder portion 90, against which a head 68 of the prosthetic screw 70 seats against. The flexible abutment 80 further includes an aperture 92 extending from the shoulder portion 90 to the first end 82 of the digital abutment 80 to allow the fastener 70 to be inserted therein and threadedly received in the dental implant 10. The shoulder portion 90 is disposed between the first end 82 and the flex region 86 of the digital abutment 80 so that the screw 70 does not interfere with the flex region 86 of the flexible abutment 80. It has been found that an alloy named Nitonol having 55 percent nickel and 45 percent titanium alloy has exhibited the shape/memory property and superelasticity required for the flexible abutment 80 to simulate the flexibility of a natural tooth. The wall thickness of the flex region 86 can have a thickness of approximately 0.15 mm, while the wall thickness above and below the flex region is at least 0.2 mm or greater, such that the flex region can have a wall thickness less than 80% of a thickness of adjacent wall portions.

The flexible abutment 80 simulates the flexibility of a natural tooth to provide protection from accidental sudden forces affecting the implant and allows for connection between a natural tooth and the implant, such as by a bridge.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A flexible abutment, comprising:
a first end configured for engagement with a dental implant, and a second end adapted for engagement with a dental prosthetic device said flexible abutment including a flex region disposed between said first and second ends, wherein said flex region includes of a reduced thickness region.

2. The flexible abutment according to claim 1, wherein said flexible abutment is made from a nickel titanium alloy.

3. The flexible abutment according to claim 1, wherein said flexible abutment is made from a superelastic material.

4. The flexible abutment according to claim 1, further comprising an aperture extending from said first end to said second end and including a shoulder portion disposed between said flex region and said first end and adapted for engaging a head of a fastener thereagainst.

5. The flexible abutment according to claim 4, wherein said reduced thickness region includes a recessed groove on an interior surface of said aperture.

6. The flexible abutment according to claim 1, wherein said reduced thickness region includes a recessed groove on an exterior surface of said second end.

7. The flexible abutment according to claim 1, wherein said reduced thickness region has a thickness of less than 80 percent of a thickness of adjacent portions to said reduced thickness region.

8. The flexible abutment according to claim 1, wherein said reduced thickness region has a thickness of less than 0.15 mm and adjacent portions of said flexible abutment next to said reduced thickness region has a thickness of greater than 0.2 mm.

9. A flexible abutment, comprising:
a first end configured for engagement with a dental implant, and a second end adapted for engagement with a dental prosthetic device said flexible abutment including a flex region disposed between said first and second ends, wherein said flex region includes of a reduced thickness region, wherein said flexible abutment is made from a nickel titanium alloy and an aperture extends from said first end to said second end and includes a shoulder portion disposed between said flex region and said first end and adapted for engaging a head of a fastener thereagainst.

10. The flexible abutment according to claim 9, wherein said reduced thickness region includes a recessed groove on an interior surface of said aperture.

11. The flexible abutment according to claim 9, wherein said reduced thickness region includes a recessed groove on an exterior surface of said second end.

12. The flexible abutment according to claim 9, wherein said reduced thickness region has a thickness of less than 80 percent of a thickness of adjacent portions to said reduced thickness region.

13. The flexible abutment according to claim 9, wherein said reduced thickness region has a thickness of less than 0.15 mm and adjacent portions of said flexible abutment next to said reduced thickness region have a thickness of greater than 0.2 mm.
